(19) United States
(12) Patent Application Publication
(10) Pub. No.: US 2015/0199171 A1
(43) Pub. Date: Jul. 16, 2015

(54) HANDWRITTEN DOCUMENT PROCESSING APPARATUS AND METHOD

(71) Applicant: Kabushiki Kaisha Toshiba, Tokyo (JP)

(72) Inventors: Daisuke Hirakawa, Saitama Saitama (JP); Kazunori Imoto, Kawasaki Kanagawa (JP); Yasunobu Yamauchi, Yokohama Kanagawa (JP)

(21) Appl. No.: 14/667,528

(22) Filed: Mar. 24, 2015

Related U.S. Application Data
(63) Continuation of application No. PCT/JP2013/076458, filed on Sep. 24, 2013.

(30) Foreign Application Priority Data
Sep. 25, 2012 (JP) 2012-210874

(51) Int. Cl. G06F 3/16; G06F 3/0488

(52) U.S. Cl. CPC G06F 3/165; G06F 3/04883

(57) ABSTRACT

According to one embodiment, a handwritten document processing apparatus includes the following units. The stroke input unit inputs stroke information indicating strokes and times of the strokes. The voice recording unit records voice information, a playback operation of which is configured to be started from a designated time. The stroke structuration unit structures the stroke information into a row structure by combining a plurality of strokes in a row direction. The cue time calculation unit calculates a cue time of the voice information associated with the row structure. The playback control unit controls to play back the voice information from the cue time in accordance with an instruction to the row structure.

### CROSS-REFERENCE TO RELATED APPLICATIONS

This application is a Continuation Application of PCT Application No. PCT/JP2013/076458, filed Sep. 24, 2013 and based upon and claiming the benefit of priority from Japanese Patent Application No. 2012-210874, filed Sep. 25, 2012, the entire contents of all of which are incorporated herein by reference.

### FIELD

Embodiments described herein relate generally to a handwritten document processing apparatus and method.

### BACKGROUND

A technique for allowing the user to record a voice simultaneously with a handwriting input to create a note, conference minutes, or the like with voice data in a handwritten document processing apparatus such as a tablet computer including a pen input interface, has been proposed.

### BRIEF DESCRIPTION OF THE DRAWINGS

FIG. 1 is a block diagram showing a handwritten document processing apparatus according to the first embodiment;

FIG. 2 is a flowchart showing the processing sequence of the handwritten document processing apparatus according to the first embodiment;

FIG. 3 is a view for explaining structuration of strokes;

FIG. 4 is a view for explaining structuration of strokes;

FIG. 5 is a view for explaining structuration of strokes;

FIG. 6 is a view showing a voice playback start tap position;

FIG. 7 is a view showing a voice playback start tap position;

FIG. 8 is a block diagram showing a handwritten document processing apparatus according to the second embodiment;

FIG. 9 is a flowchart showing the processing sequence of the handwritten document processing apparatus according to the second embodiment;

FIG. 10 is a view showing an example of structuration of voice data by means of voice interval detection;

FIG. 11 is a block diagram showing a handwritten document processing apparatus according to the third embodiment;

FIG. 12 is a flowchart showing the processing sequence of the handwritten document processing apparatus according to the third embodiment;

FIG. 13 is a view showing an example of structuration of strokes;

FIG. 14 is a view showing another example of structuration of strokes;

FIG. 15 is a view showing progress of voice playback;

FIG. 16 is a view showing a granularity change of a cue playback position;

FIG. 17 is a view showing hierarchization of cue playback positions;

FIG. 18 is a block diagram showing an example of the hardware arrangement of a handwritten document processing apparatus according to an embodiment; and

FIG. 19 is a view showing a configuration example which implements a handwritten document processing apparatus using a network.

### DETAILED DESCRIPTION

In general, according to one embodiment, a handwritten document processing apparatus includes a stroke input unit, a voice recording unit, a stroke structuration unit, a cue time calculation unit, and a playback control unit. The stroke input unit inputs stroke information indicating strokes and times of the strokes. The voice recording unit records voice information, a playback operation of which is configured to be started from a designated time. The stroke structuration unit structures the stroke information into a row structure by combining a plurality of strokes in a row direction. The cue time calculation unit calculates a cue time of the voice information associated with the row structure. The playback control unit controls to play back the voice information from the cue time in accordance with an instruction to the row structure.

Embodiments will be described hereinafter with reference to the drawings.

A handwritten document processing apparatus according to this embodiment is applied to a notebook application of, for example, a tablet computer including a pen input interface and voice input interface. This application allows the user to input note contents by handwriting and to collect and record voices of speakers and the user himself or herself via a microphone. This application can display a handwritten document and can play back recorded voices by reading out note data which associates handwriting-input strokes and recorded voice data. This embodiment is directed to improvement of operability of a cue playback operation of voice data associated with a handwritten document.

### First Embodiment

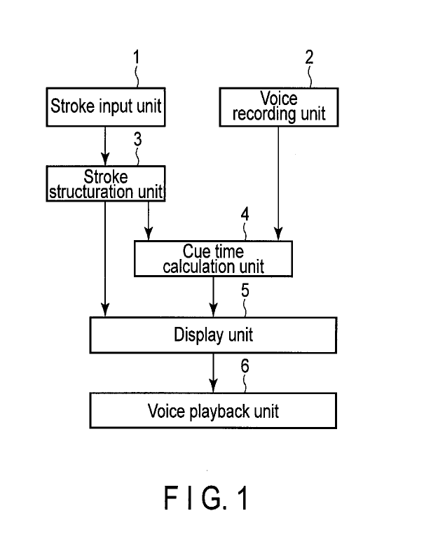

FIG. 1 is a block diagram showing a handwritten document processing apparatus according to the first embodiment. This apparatus includes a stroke input unit 1, voice recording unit 2, stroke structuration unit 3, cue time calculation unit 4, display unit 5, and voice playback unit 6.

The stroke input unit 1 inputs stroke information via a pen input interface. “Stroke” is a handwriting-input stroke image. More specifically, “stroke” represents a locus from when a pen or the like is brought into contact with an input surface until it is released. For example, stroke information is associated with each stroke image from when the pen is brought into contact with a touch panel until it is released. The stroke information includes identification information required to identify a stroke, a start time T as a time of an initial point where the pen was in contact with the touch panel, and a time series of coordinates of a plurality of points which define a locus formed when the pen which contacted the touch panel was moved.

The voice recording unit 2 records voice information via a voice input interface. Voice information may have an arbitrary format, such as that which allows control of its playback operation, and is required to allow to at least start, pause, and end of the playback operation and allow to start the playback operation from a designated playback start time (to be referred to as “cue playback” hereinafter). Also, the voice information may be structured by voice interval detection, speaker recognition, and keyword extraction. The structuration of the voice information will be explained in the second embodiment.

The stroke structuration unit 3 structures stroke information into a row structure by combining a plurality of strokes in a row direction. To have this row structure as a unit, a cue playback start time (to be referred to as a “cue time” hereinafter) is associated with the row structure.

The cue time calculation unit 4 calculates a cue time of voice information to be associated with the row structure of stroke information. The display unit 5 displays handwriting-input strokes on the touch panel. The voice playback unit 6 is controlled to play back voice information from a cue time calculated by the cue time calculation unit 4 in response to an instruction operation to the row structure of strokes displayed on the touch panel.

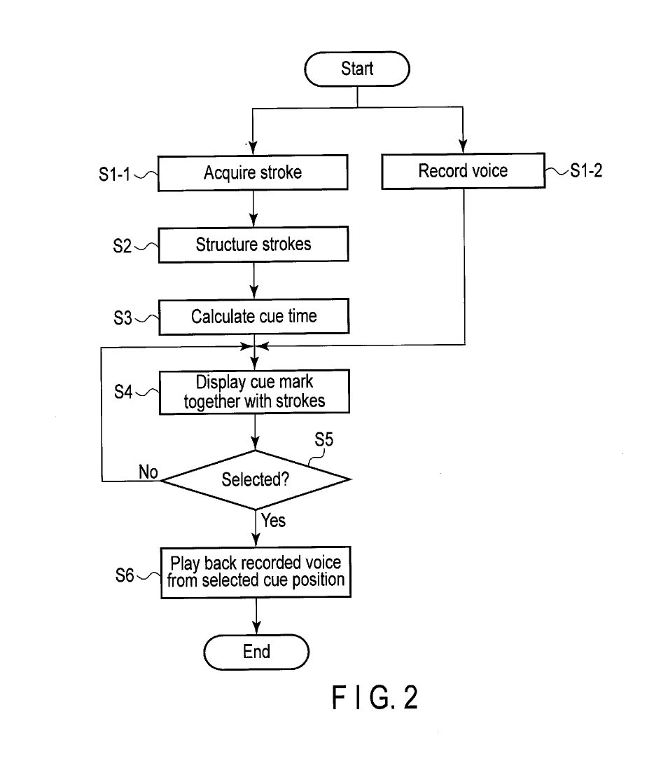

FIG. 2 is a flowchart showing the processing sequence of the handwritten document processing apparatus according to the first embodiment.

### Step S1-1 and Step S1-2

After the user launches the notebook application, he or she starts to create and record a new note with voice data. Thus, the user can make a handwriting input by operating the pen on the touch panel. When the user starts a recording button, voice recording is started. Parallel to recording, the user makes a handwriting input to the note. When the user ends the recording, he or she can subsequently make a handwriting input but cannot associate a cue position of voice data with strokes input after the end of recording.

The stroke input unit 1 inputs stroke information to the handwritten document processing apparatus according to this embodiment via the pen input interface, and the voice recording unit 2 acquires voice information recorded via the voice input interface.

### Step S2

The stroke structuration unit 3 structures stroke information into a row structure by combining a plurality of already input strokes in a row direction.

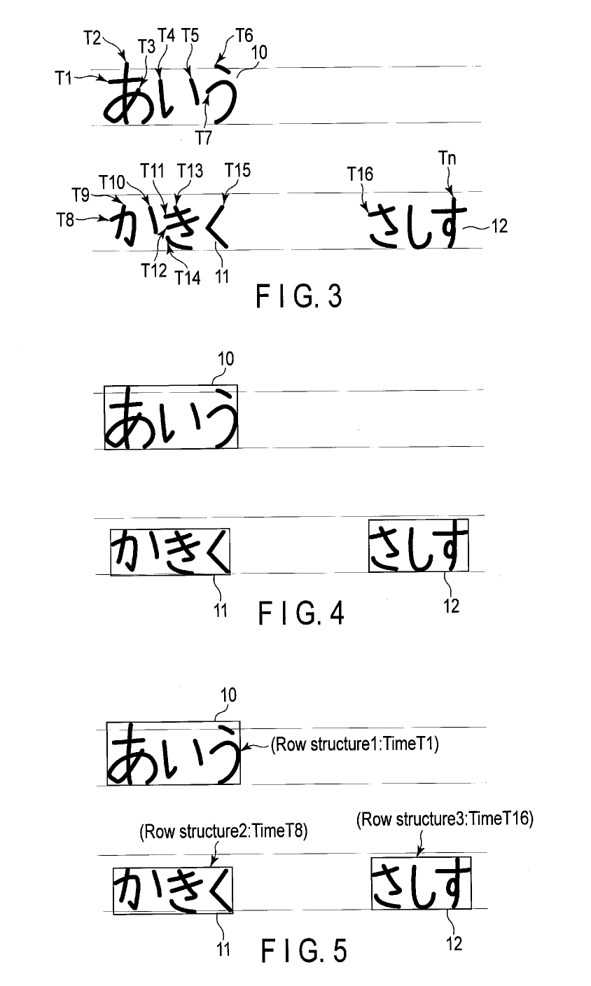

FIG. 3 shows an example of stroke information. Each individual stroke handwriting-input by the user has a start time. A start time of the first stroke is T1, that of the next stroke is T2, that of the third stroke is T3, . . . , that of the n-th stroke is Tn. Each of these start times corresponds to a time of an initial point where the pen was in contact with the touch panel in each stroke.

As shown in FIG. 4, strokes respectively having start times T1 to T7 in a group 10 are combined in the row direction to obtain a row structure 1, strokes respectively having start times T8 to T15 in a group 11 are combined in the row direction to obtain a row structure 2, and strokes respectively having start times T16 to Tn in a group 12 are combined in the row direction to obtain a row structure 3. For example, structuration may be attained by combining a plurality of strokes which satisfy a condition that a distance from an immediately preceding stroke falls within a threshold range. Also, like in this example, a plurality of row structures can be generated on a single row.

### Step S3

The cue time calculation unit 4 calculates a cue time of voice information recorded together with the stroke information for each of the row structures 1 to 3. For example, a stroke having an earliest input time of a plurality of strokes included in the row structure, that is, a start time of the first stroke in that row structure is set as a cue time. As shown in FIG. 5, the start time T1 of the first stroke is set as a cue time of voice information for the row structure 1, the start time T8 of the first stroke is set as a cue time of voice information for the row structure 2, and the start time T16 of the first stroke is set as a cue time of voice information for the row structure 3. Therefore, in this example, the first cue time is T1, the next cue time is T8, and the subsequent cue time is T16.

Note that the cue times of the respective row structures may be adjusted. For example, a time of an α time period before the cue time based on the stroke information is set as a cue time (T1-α, T8-α, and T16-α are respectively set). Thus, a delay when the user hears a certain voice and starts a handwriting input in response to this can be absorbed. In other words, a playback operation from the adjusted cue time can prevent an opening sentence of the voice contents from being partially omitted.

### Step S4 to Step S6

After the cue times are calculated for the respective row structures, as described above, a playback operation of recorded voice contents can be started from a corresponding cue position when the user gives an instruction by tapping a desired row structure by the pen.

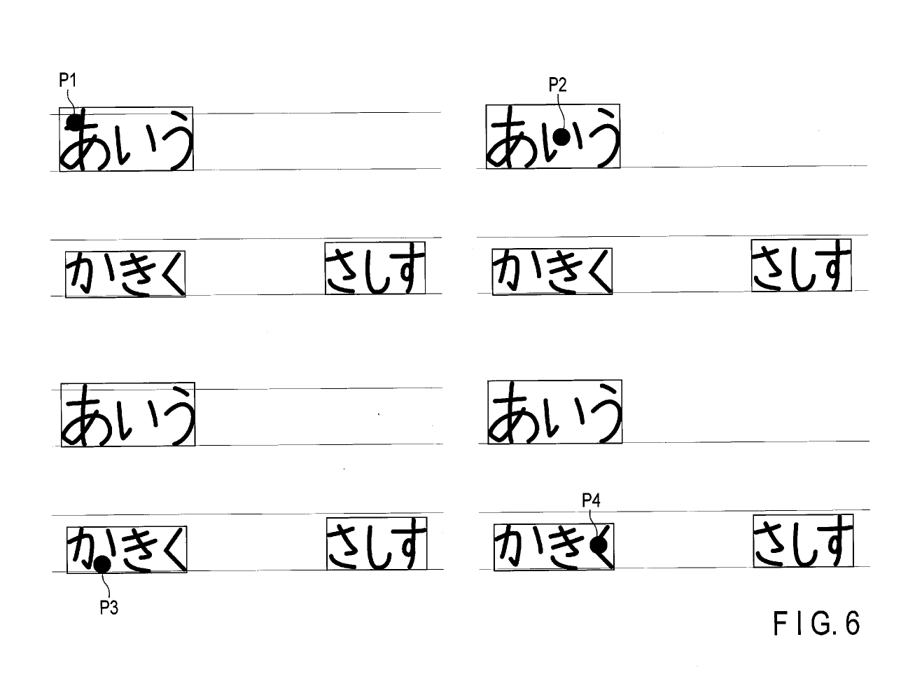

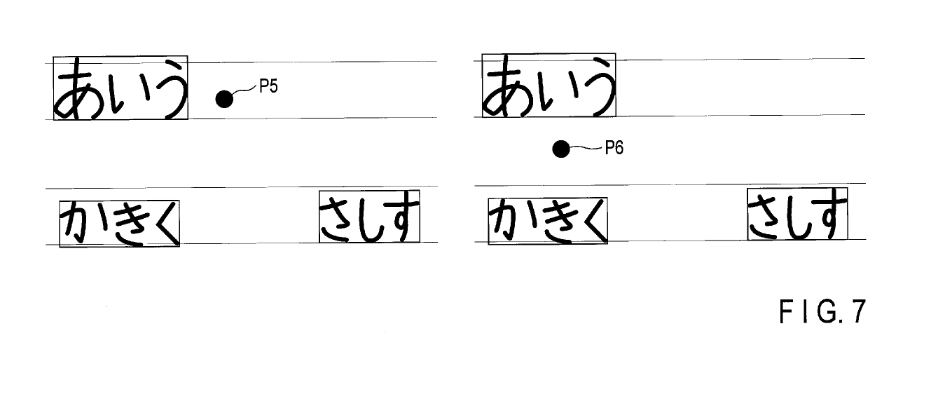

For example, when the user taps a position P1 or P2, as shown in FIG. 6, the time T1 of the same row structure 1 is selected, and a playback operation of voice information is started from the time T1. When the user taps a position P3 or P4, the time T8 of the same row structure 2 is selected, and a playback operation of voice information is started from the time T8. On the other hand, when the user taps a position separated away from (the row structure of) a stroke like positions P5 and P6, as shown in FIG. 7, a playback operation of voice information is not started for both the positions.

Note that a symbol mark indicating that a cue of voice information is associated may be displayed in the vicinity of a stroke, and an instruction may be given via this cue mark (step S4).

According to the aforementioned first embodiment, a cue playback operation of voice information can be attained in association with a row structure of strokes. Note that a display mode may be changed to allow the user to identify a corresponding row structure of strokes when a cue playback operation is started by tapping. For example, a display color of the corresponding row structure may be changed or that row structure may be highlighted.

Also, a time bar which indicates progress of a voice playback operation may be displayed, or a display color of strokes may be changed according to a voice playback time period between row structures. The user may be allowed to set to end a cue playback operation. In this case, a cue time of the next row structure may be set as an end time. It is also preferable to identifiably display (the row structure of) strokes with which no voice information is associated, that is, strokes for which (a cue position of) voice information is not available even when the stroke is tapped.

### Second Embodiment

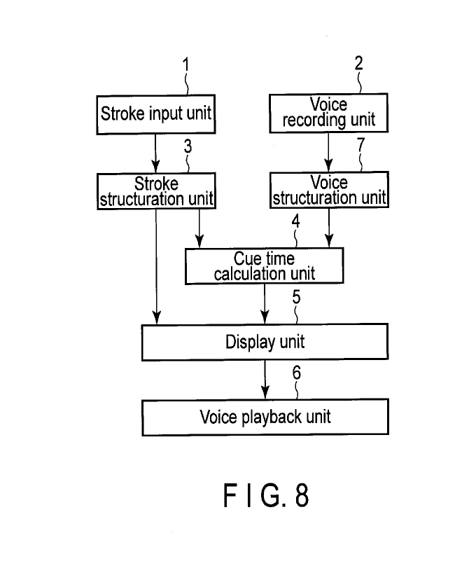

FIG. 8 is a block diagram showing a handwritten document processing apparatus according to the second embodiment. The same reference numerals as in the first embodiment denote the same components, and a description thereof will not be repeated. In the second embodiment, not only stroke information but also voice information is structured. More specifically, the handwritten document processing apparatus according to the second embodiment includes a voice structuration unit 7 which structures voice information recorded by a voice recording unit 2.

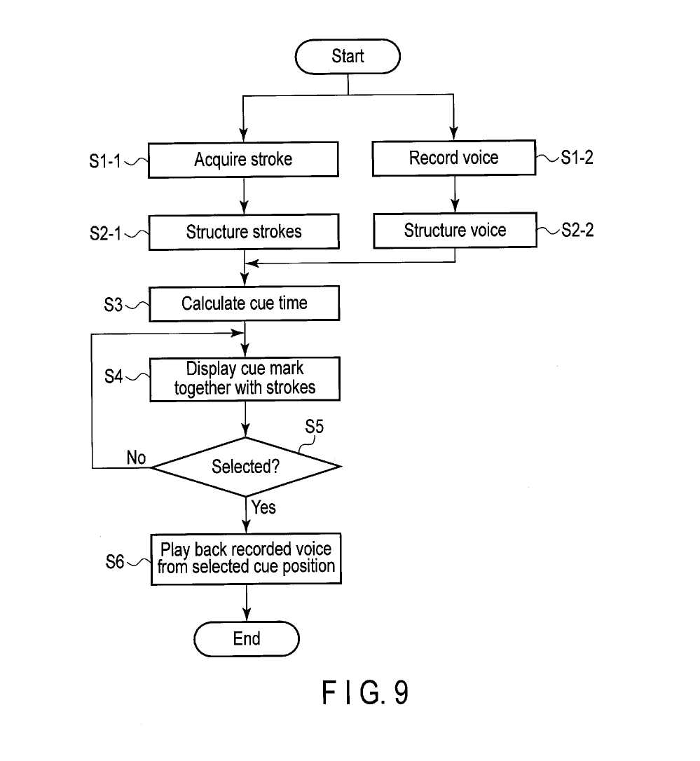

FIG. 9 is a flowchart showing the processing sequence of the handwritten document processing apparatus according to the second embodiment. In step S2-2, the voice structuration unit 7 structures voice information acquired by the voice recording unit 2 by, for example, voice interval detection. Thus, one or a plurality of voice structures each having time information (for example, start and end times of a voice interval) can be obtained.

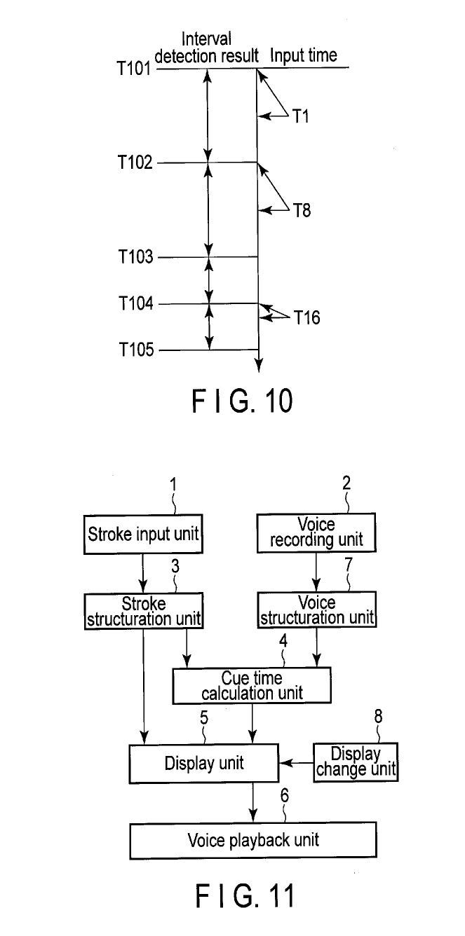

Since the voice structure includes the time information, as described above, it is used to calculate a cue time described in the first embodiment. In this embodiment, by comparing a cue time of a row structure with respective times of a detected voice interval, a cue time is calculated. For example, assume that as a result of interval detection of voice information, a voice structure between times T101 and T102, that between times T102 and T103, that between times T103 and T104, and that between times T104 and T105 are obtained, as shown in FIG. 10.

A cue time calculation unit 4 sets a time which is before a time of each row structure and is closest to that time as a cue time. As for a row structure 1, the closest time T101 before a time T1 is set as a cue time. As for a row structure 2, the closest time T102 before the time T8 is set as a cue time. As for a row structure 3, the closest time T104 before the time T16 is set as a cue time.

Note that this embodiment has exemplified the structuration of voice information by voice interval detection. However, the present embodiment is not limited to this, and structuration may be attained by, for example, time equal division. Also, various structuration methods may be combined.

According to the second embodiment, the same effects as in the first embodiment can be provided, and the cue precision can be improved based on the structuration of the voice information.

Note that a voice interval detection technique may use a method using two thresholds described in [Nimi, “Speech Recognition” (KYORITSU SHUPPAN CO., LTD) p. 68-69]. Alternatively, a method described in Japanese Patent No. 2989219 may be used.

### Third Embodiment

FIG. 11 is a block diagram showing a handwritten document processing apparatus according to the third embodiment. The same reference numerals denote the same components as in the first and second embodiments, and a description thereof will not be repeated. In the third embodiment, stroke information and voice information are structured, and a voice structure is also visualized and displayed. This visual information of the voice structure is displayed between row structures of stroke information. The apparatus further includes a display change unit 8 which changes a display granularity of visual information.

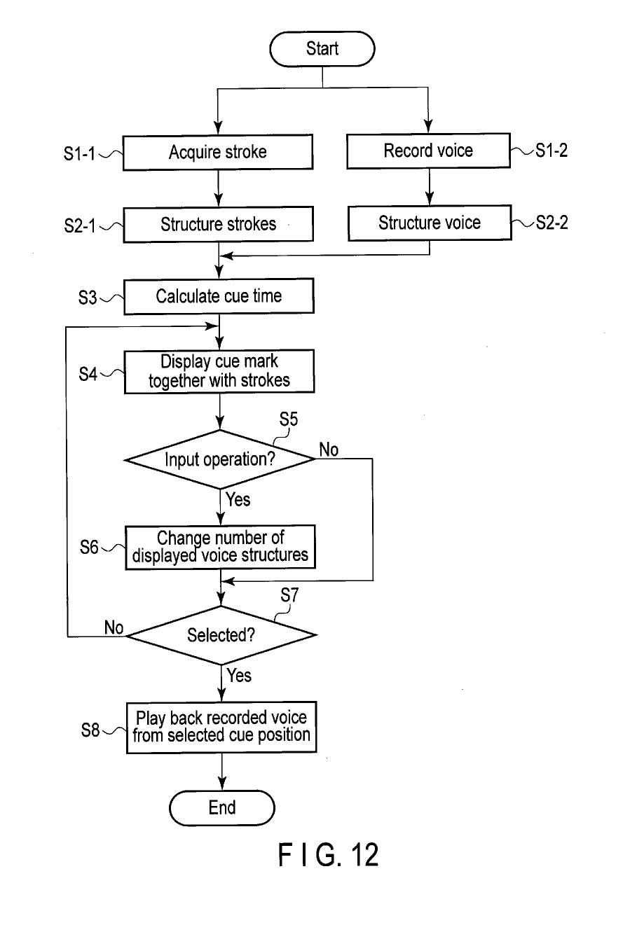

FIG. 12 is a flowchart showing the processing sequence of the handwritten document processing apparatus according to the third embodiment. In step S2-2, the voice structuration unit 7 structures voice information acquired by a voice recording unit 2, and obtains visual information of that voice structure. The visual information includes a keyword extracted from the voice information, information indicating a speaker specified from the voice information by a speaker recognition technique, and like.

Visual information of a voice structure may be displayed before a cue position is selected (before the start of a cue playback operation) or that of a corresponding voice structure may be displayed when a cue position is selected. Also, visual information may be partially displayed according to the progress of a playback operation of voice information from the selected cue position.

As in the second embodiment, a cue time may be calculated using information of a voice structure (step S3). However, in this embodiment, step S3 may be omitted.

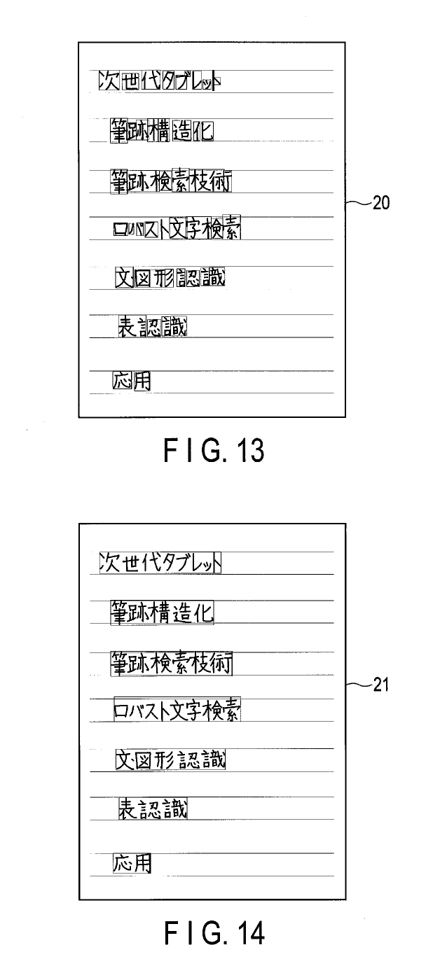

FIGS. 13 and 14 show row structures of strokes. FIG. 13 shows an example 20 of row structures of strokes, each structure of which corresponds to roughly one character, and FIG. 14 shows an example 21 of row structures of strokes corresponding to a plurality of character strings. A cue playback operation and visualization of voice information according to the third embodiment will be described below taking the case of FIG. 14 as an example.

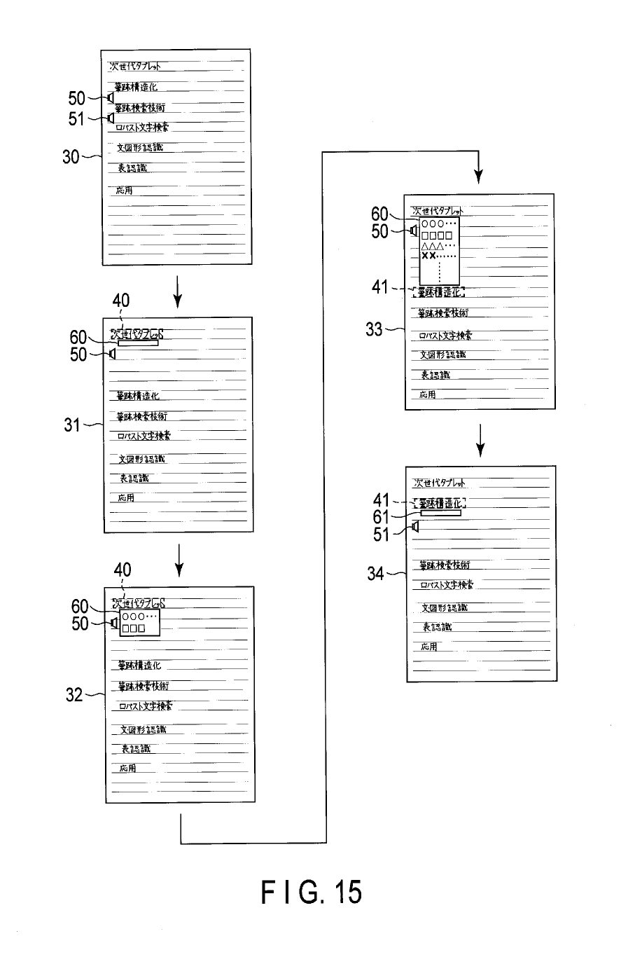

FIG. 15 shows an example of the progress of a voice playback operation. Assume that a handwriting input is made, as shown on a screen 30, and voice information is recorded in synchronism with this input. Together with input strokes, cue marks 50 and 51 required to instruct to cue voice information are displayed. For example, when the user taps the first cue mark 50 to start a playback operation, a corresponding row structure 40 of strokes is identifiably displayed (to have, for example, a different display color). Also, a time bar 60 indicating the progress of the playback operation is displayed (screen 31). On a region of the time bar 60, visual information of a voice structure is displayed synchronously (screens 32 and 33). Note that visual information may be displayed in a region other than the time bar 60.

When the voice playback operation further progresses, and reaches a next row structure 41 (screen 33), the row structure 41 is identifiably displayed. Below the row structure 41, a voice structure time bar 61 corresponding to this row structure 41 is displayed (screen 34). Note that by tapping the cue mark 50 or 51 during the playback operation, the playback operation can be repeated by returning to a cue position.

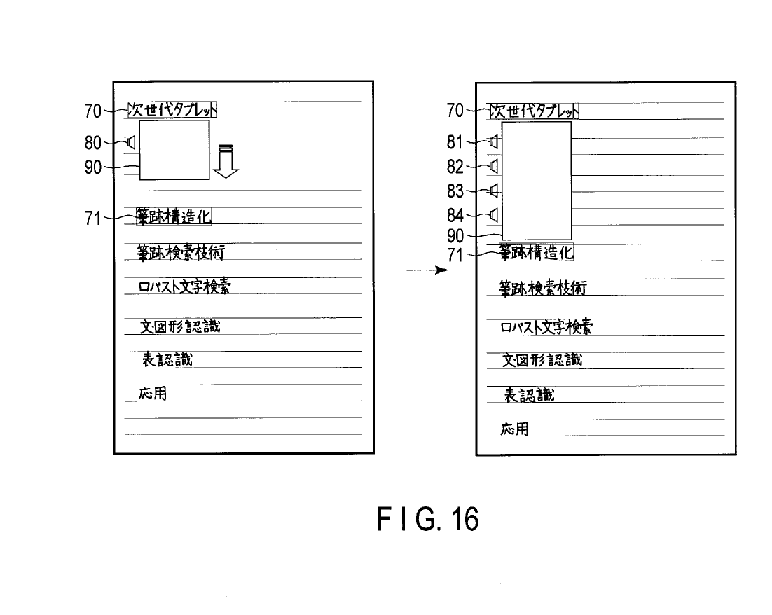

FIG. 16 shows a granularity change of a cue playback position. FIG. 16 shows a cue mark 80 indicating one cue position. For example, when the user makes a pinch-out operation to enlarge a space between rows (structures) while simultaneously tapping row structures 70 and 71 on a screen, the number of displayed cue marks is changed (step S6). The number of displayed cue marks corresponds to a granularity (number) of voice structures (pieces of visual information). If the number of displayed cue marks is small, the granularity is large; otherwise, it is small. On the other hand, when the user makes a pinch-in operation to reduce a space between rows (structures) while simultaneously tapping the row structures 70 and 71 on the screen, the granularity can be lowered. Note that the granularity may be changed by the number of taps on the row structure.

The playback time bar is extended according to the granularity of visualization. A time bar 90 is displayed in the case of one cue mark 80, and indicates that the progress of the playback operation is about 60%. A time bar 91 is displayed in the case of four cue marks 81 to 84, and indicates that the playback operation is nearly completed, and is about to transit to the next row structure. By tapping any of the cue marks 81 to 84, the playback operation can be started from the tapped position.

Note that a symbol mark which visualizes a keyword extracted from voice information may be used in place of a cue mark.

How to decide the contents of visual information of a voice structure according to the number of cue marks (granularity) will be described below. For example, when the number of cue marks is one, visual information at an intermediate time during a time period between playback start and end times may be displayed, and a keyword having a highest frequency of occurrence may be displayed in case of keyword extraction. For example, when the number of cue marks is two, pieces of visual information close to two times obtained by dividing a time period between playback start and end times into three may be selected.

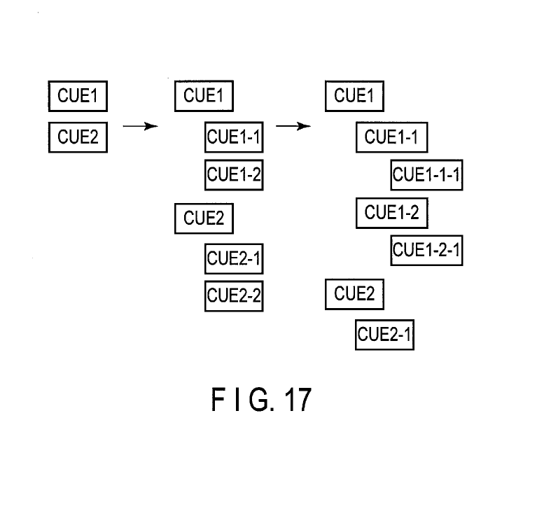

Also, as shown in FIG. 17, voice structures (visual information) may be hierarchized. With this structure, the number of voice structures (visual information) can be changed as if a folder were unfolded/folded.

According to the third embodiment, a voice structure can be visualized and displayed, and a cue playback operation for a time period (voice interval) in which no stroke input is made can also be performed. Therefore, operability of a cue playback operation can be further improved.

Note that there are two basic types of speaker recognition using voice information: speaker identification and speaker collation. A literature (J. P. Campbell, “Speaker Recognition: A Tutorial,” Proc. IEEE, Vol. 85, No. 9, pp. 1437-1462 (1997)) may be used as a reference. As for keyword extraction from voice information, NEC Corporation, “Keyword extraction by optimization of degree of keyword matching” (CiNii), Internet URL: www.nec.jp/press/ja/1110/0603.html may be used as a reference.

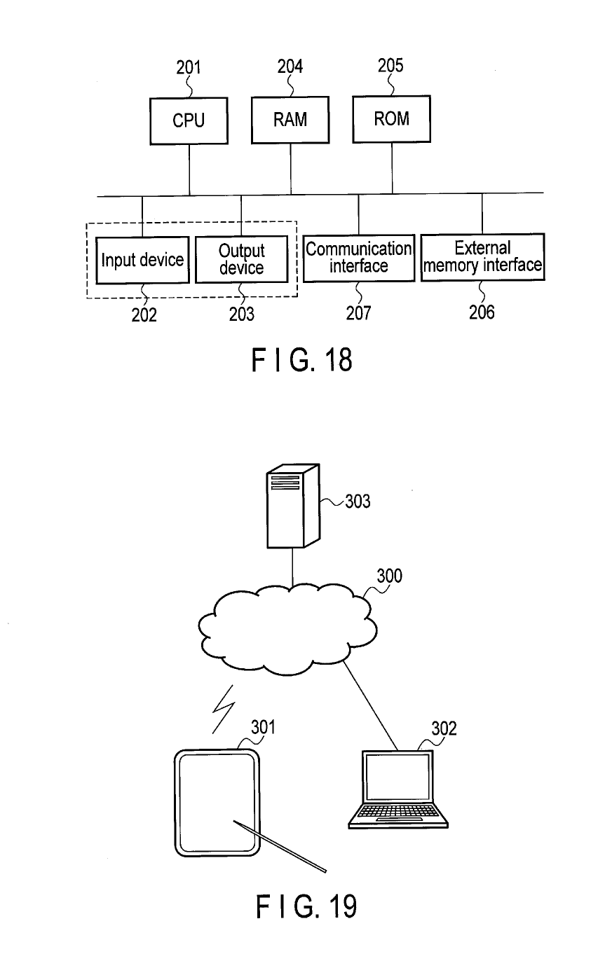

FIG. 18 is a block diagram showing an example of the hardware arrangement which implements the handwritten document processing apparatus of the first to third embodiments. Referring to FIG. 18, reference numeral 201 denotes a CPU; 202, a predetermined input device; 203, a predetermined output device; 204, a RAM; 205, a ROM; 206, an external memory interface; and 207, a communication interface. For example, when a touch panel is used, for example, a liquid crystal panel, a pen, a stroke detection device arranged on the liquid crystal panel, and the like are used.

For example, some components shown in FIGS. 1, 8, and 14 may be arranged on a client, and the remaining components shown in FIGS. 1, 8, and 14 may be arranged on a server.

For example, FIG. 19 exemplifies a state in which a handwritten document processing apparatus of this embodiment is implemented when a server 303 is connected on a network 300 such as an intranet and/or the Internet, and clients 301 and 302 communicate with the server 303 via the network 300.

Note that in this example, the client 301 is connected to the network 300 via wireless communications, and the client 302 is connected to the network 300 via wired communications.

The clients 301 and 302 are normally user apparatuses. The server 303 may be arranged on, for example, a LAN such as an office LAN, or may be managed by, for example, an Internet service provider. Alternatively, the server 303 may be a user apparatus, so that a certain user provides functions to other users.

Various methods of distributing the components in FIGS. 1, 8, and 14 to the clients and server are available.

Instructions of the processing sequence described in the aforementioned embodiments can be executed based on a program as software. A general-purpose computer system pre-stores this program, and loads the program, thereby obtaining the same effects as those of the handwritten document processing apparatus of the aforementioned embodiments. Instructions described in the aforementioned embodiments are recorded in a recording medium such as a magnetic disk (flexible disk, hard disk, etc.), optical disk (CD-ROM, CD-R, CD-RW, DVD-ROM, DVD±R, DVD±RW, etc.), a semiconductor memory, and the like as a program that can be executed by a computer. The storage format of such recording medium is not particularly limited as long as the recording medium is readable by a computer or embedded system. The computer loads the program from this recording medium, and controls a CPU to execute instructions described in the program based on the program, thereby implementing the same operations as the handwritten document processing apparatus of the aforementioned embodiments. Of course, the computer may acquire or load the program via a network.

Also, an OS (Operating System) or MW (middleware) such as database management software or network, which run on a computer may execute some of processes required to implement this embodiment based on instructions of the program installed from the recording medium into the computer or embedded system.

Furthermore, the recording medium of this embodiment is not limited to a medium separate from the computer or embedded system, and includes a recording medium which stores or temporarily stores a program downloaded via a LAN or Internet.

The number of recording media is not limited to one, and the recording medium of this embodiment includes a case in which the processes of this embodiment are executed from a plurality of media. Hence, the configuration of the medium may use an arbitrary configuration.

Note that the computer or embedded system of this embodiment is required to execute respective processes of this embodiment, and may adopt any of arrangements such as a single apparatus such as a personal computer or microcomputer or a system in which a plurality of apparatuses are connected via a network.

The computer of this embodiment is not limited to a personal computer, includes an arithmetic processing device, microcomputer and the like included in an information processing apparatus, and collectively means a device and apparatus which can implement the functions of this embodiment based on the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A handwritten document processing apparatus comprising:
a stroke input unit that inputs stroke information indicating strokes and times of the strokes;
a voice recording unit that records voice information, a playback operation of which is configured to be started from a designated time;
a stroke structuration unit that structures the stroke information into a row structure by combining a plurality of strokes in a row direction;
a cue time calculation unit that calculates a cue time of the voice information associated with the row structure; and
a playback control unit that controls to play back the voice information from the cue time in accordance with an instruction to the row structure.

2. The apparatus of claim 1, further comprising a voice structuration unit that structures the voice information into a voice structure,
wherein the cue time calculation unit calculates the cue time based on the row structure and the voice structure.

3. The apparatus of claim 1, further comprising:
a voice structuration unit that structures the voice information into a voice structure; and
a visualization unit that displays visual information of the voice structure.

4. The apparatus of claim 2, wherein the voice structuration unit structures the voice information based on any of voice interval detection, keyword extraction, and speaker recognition.

5. The apparatus of claim 3, wherein the visualization unit hierarchically displays the visual information.

6. The apparatus of claim 3, further comprising a display change unit that changes a display granularity of the visual information in accordance with an instruction to the row structure.

7. A computer-readable recording medium that stores a program for controlling a computer to function as:
a stroke input unit that inputs stroke information indicating strokes and times of the strokes;
a voice recording unit that records voice information, a playback operation of which is configured to be started from a designated time;
a stroke structuration unit that structures the stroke information into a row structure by combining a plurality of strokes in a row direction;
a cue time calculation unit that calculates a cue time of the voice information associated with the row structure; and
a playback control unit that controls to play back the voice information from the cue time in accordance with an instruction to the row structure.

8. A handwritten document processing apparatus comprising:
a processor configured to input stroke information indicating strokes and times of the strokes, to record voice information, a playback operation of which is configured to be started from a designated time, to structure the stroke information into a row structure by combining a plurality of strokes in a row direction, to calculate a cue time of the voice information associated with the row structure, and to control to play back the voice information from the cue time in accordance with an instruction to the row structure; and
a memory connected to the processor.
